(19) United States
(12) Patent Application Publication
(10) Pub. No.: US 2026/0217228 A1
(43) Pub. Date: Jul. 30, 2026

(54) METHOD FOR CONTROLLING AN ELECTROMECHANICAL BRAKE SYSTEM OF A VEHICLE DURING A STANDING-START OPERATION OF THE VEHICLE AND VEHICLE COMPRISING AN ELECTROMECHANICAL BRAKE SYSTEM

(71) Applicant: Robert Bosch GmbH, Stuttgart (DE)

(72) Inventors: Christian Kaiser, Stuttgart (DE); Patrick Ruck, Stuttgart (DE); Robert Schmidt, Ludwigsburg (DE)

(21) Appl. No.: 19/448,428

(22) Filed: Jan. 14, 2026

(30) Foreign Application Priority Data
Jan. 27, 2025 (DE) 10 2025 102 735.8

(51) Int. Cl. B60T 8/17

(52) U.S. Cl. CPC B60T 8/17; B60T 2201/06

(57) ABSTRACT

A method for controlling an electromechanical brake system of a vehicle during a standing-start operation of the vehicle. The brake system includes: a first electromechanical service brake provided on a first axle of the vehicle and a second electromechanical service brake provided on a second axle of the vehicle. The first electromechanical service brake includes a locking mechanism using which the first service brake can also be operated as a parking brake. The method includes: releasing the locking mechanism, setting a first braking force on the first service brake to a first initial braking force, setting a second braking force on the second service brake to a second initial braking force, reducing the first braking force from the first initial braking force at a first rate of reduction over time and the second braking force from the second initial braking force at a second rate of reduction over time.

### CROSS REFERENCE

The present application claims the benefit under 35 U.S.C. § 119 of Germany Patent Application No. De 10 2025 102 735.8 filed on January 27, 2025, which is expressly incorporated herein by reference in its entirety.

### FIELD

The present disclosure relates to a method for controlling an electromechanical brake system of a vehicle during a standing-start operation of the vehicle and a vehicle comprising an electromechanical brake system.

### BACKGROUND INFORMATION

Automated parking brakes (APB) can be engaged and disengaged using other mechanisms in addition to an APB button, for example when the vehicle is ready to drive (e.g. engine is running, gear is engaged) and the driver actuates the accelerator pedal thus clearly indicating their wish to start driving. To ensure the most comfortable start possible without the vehicle rolling backward, the release process involves a force balance based on the downhill force corresponding to the current slope on which the vehicle is standing and the driving force provided by the engine of the vehicle. If the driving force exceeds the current downhill force, the APB is triggered to release and the vehicle can start moving. The force with which the brake shoes of a brake are pressed against a corresponding brake disc is reduced with a constant ramp (rate of change over time). This procedure can be found in both classic hydraulic brake systems and electromechanical brake systems, in which, with the aid of a locking mechanism (e.g. a locking pawl), electromechanical service brakes are also used as parking brakes.

Conventional parking brakes are often installed on only one vehicle axle. Even during only slightly dynamic standing-start operations, the combination of a relatively slow force reduction and holding force on only one axle can cause the vehicle to pitch before or during a standing-start operation, which can be perceived by the vehicle occupants as unpleasant.

### SUMMARY

It is an object of the present disclosure to eliminate the problems of conventional parking brakes during standing-start operations.

This object may be achieved in a first aspect of the present disclosure by a method for controlling an electromechanical brake system of a vehicle during a standing-start operation of the vehicle, wherein the brake system comprises: at least one first electromechanical service brake provided on a first axle of the vehicle and at least one second electromechanical service brake provided on a second axle of the vehicle, wherein the at least one first electromechanical service brake comprises a locking mechanism by means of which the at least one first service brake can also be operated as a parking brake. According to an example embodiment, the method comprises:

releasing the locking mechanism,

setting a first braking force on the at least one first service brake to a first initial braking force,

setting a second braking force on the at least one second service brake to a second initial braking force,

reducing the first braking force from the first initial braking force at a first rate of reduction over time and the second braking force from the second initial braking force at a second rate of reduction over time.

Building up a respective braking force on the first and also the second axle of the vehicle at the beginning of the standing-start operation and then reducing it in a defined manner, makes it possible suppress unpleasant pitching of the vehicle. This improves comfort when the vehicle starts driving in comparison to a method in which a braking force is provided on only one axle during a standing-start operation.

Reducing the first braking force from the first initial braking force and reducing the second braking force from the second initial braking force can begin at substantially the same time. This time can, for instance, be the time at which the first braking force reaches the first initial braking force, which can be determined in advance; i.e. reaching the first initial braking force triggers the reduction of the braking forces on the first and the second axle. In this case, the braking force applied to the second axle at the time at which the first braking force reaches the first initial braking force is the second initial braking force.

The first axle of the vehicle can be a front axle of the vehicle, for example. The second axle of the vehicle can be a rear axle of the vehicle, for example. The assignment between the first and the second axle on the one hand and the front and the rear axle on the other hand can also be reversed.

Of the at least one first service brake and the at least one second service brake, only the first service brake can be configured to also be operated as a parking brake. This means that a locking mechanism is provided only on the at least one first service brake.

In assignment to the wheels mounted on the first axle, the at least one first electromechanical service brake can comprise a plurality of electromechanical brakes configured to brake the corresponding wheels. If the first axle is a front axle of the vehicle, the at least one first electromechanical service brake can comprise an electromechanical brake mounted on a left front wheel of the vehicle and an electromechanical brake mounted on a right front wheel of the vehicle.

In assignment to the wheels mounted on the second axle, the at least one second electromechanical service brake can similarly comprise a plurality of electromechanical brakes configured to brake the corresponding wheels. If the second axle is a rear axle of the vehicle, the at least one second electromechanical service brake can comprise an electromechanical brake mounted on a left rear wheel of the vehicle and an electromechanical brake mounted on a right rear wheel of the vehicle.

The at least one first electromechanical service brake and the at least one second electromechanical service brake can, for instance, each comprise an electric motor and a rotation-translation gear which is configured to convert a rotational movement of a shaft of the electric motor into a translational movement to bring a brake pad of the respective brake into physical contact with a brake disc or release it from said brake disc.

The at least one first electromechanical service brake and the at least one second electromechanical service brake can be controlled via the power supply to the associated electric motor, for example.

According to an example embodiment, the locking mechanism of the at least one first electromechanical service brake can comprise a locking pawl and a ratchet wheel, for instance, which, in cooperation with one another, can provide a locking effect on the at least one first electromechanical service brake so that a braking force can be maintained without further energy supply while the vehicle is parked.

To be able to prevent unintentional unlocking of the locking mechanism, the method can further include checking at predetermined time intervals whether the driver wishes to start driving; for example based on an actuation of an accelerator pedal, a turn signal or a gear shift. Only after it has been determined that the driver wishes to start driving can the locking mechanism of the at least one first service brake be unlocked.

To prevent or minimize any impairment of driving comfort when the vehicle starts driving it can be provided that one or both of the first and the second rate of reduction over time depend on a drive state of the vehicle. The drive state can include a driving force of the vehicle, for instance, or can be a driving force of the vehicle. This makes it possible to prevent unintended pitching of the vehicle when the vehicle starts driving. This also makes it possible to set the first and the second rate of reduction such that the driving force of the vehicle exceeds a downhill force acting in the opposite direction to the desired direction of travel when starting on a slope, as a result of which unintentional rolling back of the vehicle can be prevented.

Undesirable vibrations of the vehicle when the vehicle starts driving can also be suppressed by ensuring that, during the reduction of the first braking force and the second braking force, the second braking force deviates at least temporarily or permanently from the first braking force by at most 5% or at most 10% or at most 20%, and/or that, during the reduction of the first braking force and the second braking force, the second rate of reduction over time deviates at least temporarily or permanently by at most 5% or at most 10% or at most 20% from the first rate of reduction over time.

If the vehicle is on a slope when starting, in order to suppress pitching or vibrations when the vehicle starts driving, it can be provided that the first initial braking force and the second initial braking force are each selected independently of one another based on the gradient of a surface on which the vehicle is standing. It can be provided that the second initial braking force deviates from the first initial braking force by at most 5% or at most 10% or at most 20%.

The first initial braking force and/or the second initial braking force can be less than a parking brake force; i.e. a braking force applied by the at least one first service brake while the at least one first service brake is being operated as a parking brake. This makes it possible to reduce the time needed to subsequently reduce the braking force in a defined manner, for example depending on the driving force of the vehicle, which ultimately enables dynamic starting.

The object defined at the outset may be achieved in a second aspect of the present disclosure by a vehicle which comprises an electromechanical brake system. According to an example embodiment, the vehicle electromechanical brake system comprises: at least one first electromechanical service brake provided on a first axle of the vehicle and at least one second electromechanical service brake provided on a second axle of the vehicle, wherein the at least one first electromechanical service brake comprises a locking mechanism by means of which the at least one first service brake can also be operated as a parking brake, and a control device configured to control the electromechanical brake system according to an above-described method.

Example embodiment of the present disclosure are explained in more detail in the following with reference to the figures.

### BRIEF DESCRIPTION OF DRAWING

FIG. 1 is a schematic illustration of a vehicle according to an example embodiment of the present disclosure.

FIG. 2 is a graphical presentation showing the temporal progression of a first and a second braking force as well as a driving force of the vehicle in a method and vehicle according to an example embodiment of the present disclosure.

FIG. 3 is a flow chart of an example of a method according to an example embodiment of the present disclosure.

### DETAILED DESCRIPTION OF EXAMPLE EMBODIMENTS

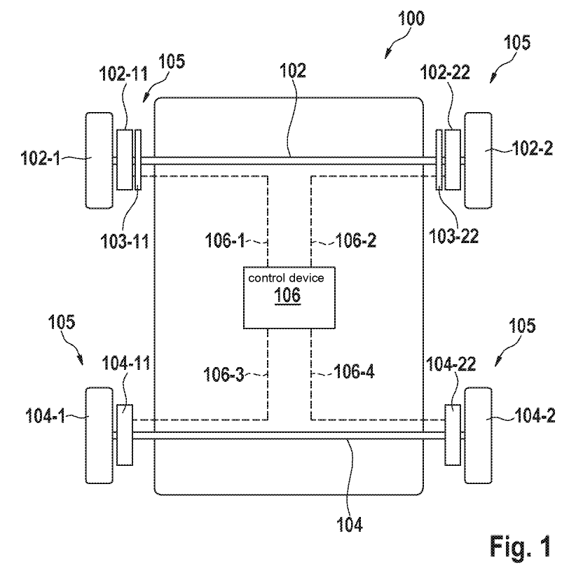

FIG. 1 is a schematic illustration of a vehicle 100 according to the present disclosure. The vehicle 100 comprises a first axle (e.g. front axle) 102 and a second axle (e.g. rear axle) 104. On the first axle 102, a first left wheel (left front wheel) 102-1 can be provided at a left end of the first axle 102 and a first right wheel (right front wheel) 102-2 can be provided at a right end of the first axle 102. A first left electromechanical service brake 102-11 configured to brake the first left wheel 102-1 can be provided on the first left wheel 102-1. A first right electromechanical service brake 102-22 configured to brake the first right wheel 102-2 can be provided on the first right wheel 102-2.

On the second axle 104, a second left wheel (left rear wheel) 104-1 can be provided at a left end of the second axle 104 and a second right wheel (right rear wheel) 104-2 can be provided at a right end of the second axle 104. A second left electromechanical service brake 104-11 configured to brake the second left wheel 104-1 can be provided on the second left wheel 104-1. A second right electromechanical service brake 104-22 configured to brake the second right wheel 104-2 can be provided on the second right wheel 104-2.

The first left electromechanical brake 102-11 comprises a first locking mechanism 103-11 by means of which a brake pad of the first left electromechanical brake 102-11 can be fixed in a state in which it is in contact with an associated brake disc. This makes it possible to also operate the first left electromechanical brake 102-11 as a parking brake.

The first right electromechanical brake 102-22 comprises a second locking mechanism 103-22 by means of which a brake pad of the first right electromechanical brake 102-22 can be fixed in a state in which it is in contact with an associated brake disc. This makes it possible to also operate the first right electromechanical brake 102-22 as a parking brake.

The first locking mechanism 103-11 and the second locking mechanism 103-22 can each comprise a locking pawl, for instance, that can be brought into engagement with a corresponding ratchet wheel to provide a locking effect.

As shown in FIG. 1, no locking mechanism is provided on the second service brakes 104-11 and 104-22 on the second axle 104; i.e. these cannot be operated as parking brakes.

The relative terms used here, such as "left", "right", "front axle", "rear axle", serve only to differentiate the different components. They are not intended to limit the present disclosure.

The first left and the first right electromechanical brake 102-1, 102-22, and the second left and the second right electromechanical brake 104-11, 104-22 are components of an electromechanical brake system 105.

The vehicle 100 also comprises a control device 106 which is configured to individually control the first left service brake 102-11, the first right service brake 102-22, the second left service brake 104-11 and the second right service brake 104-22. The control device 106 is in data exchange communication with the respective brakes via respective signal lines 106-1, 106-2, 106-3, 106-4.

The respective service brakes 102-11, 102-22, 104-11 and 104-22 can each comprise an electric motor and a rotation-translation gear which is configured to convert a rotational movement of a shaft of the electric motor into a translational movement of a respective brake pad, through which the respective brake pads can be brought into contact with the associated brake discs in order to achieve a braking effect, or can be moved away from the brake discs to terminate a braking effect.

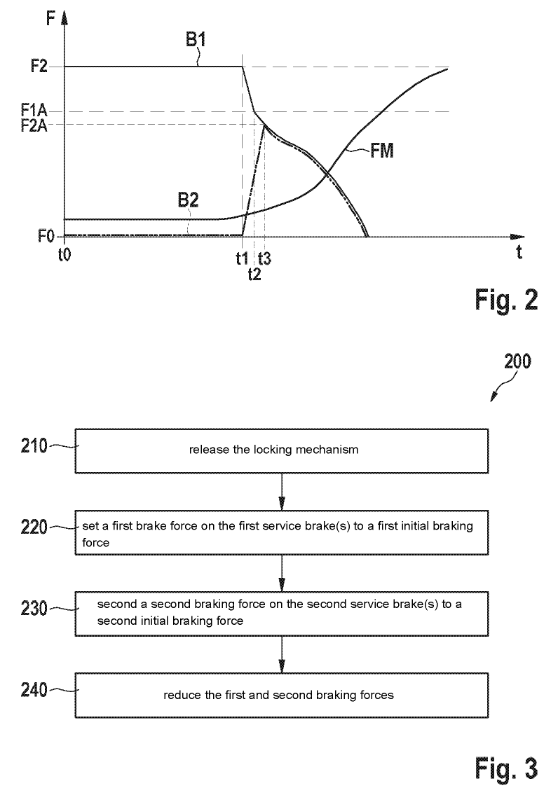

The control device 106 is configured to control the brake system 105 during a standing-start operation of the vehicle 100 according to a method described in the following with reference to FIGS. 2 and 3.

FIG. 2 is a t (time)-F (force) graph which shows the temporal progression of a first braking force (a first braking force level) B1, a second braking force (a second braking force level) B2 and a driving force FM of the vehicle 100 during a standing-start operation of the vehicle 100.

The first braking force B1 reflects a braking force on the first axle 102 of the vehicle 100. The first braking force B1 can be a braking force on the first left electromechanical brake 102-11 or the first right electromechanical brake 102-22, for example, or an average value of the braking forces on the first left electromechanical brake 102-11 and the first right electromechanical brake 102-22.

The second braking force B2 reflects a braking force on the second axle 104 of the vehicle 100. The second braking force B2 can be a braking force on the second left electromechanical brake 104-11 or the second right electromechanical brake 104-22, for example, or an average value of the braking forces on the second left electromechanical brake 104-11 and the second right electromechanical brake 104-22.

The time interval between the times t0 and t1 corresponds to a period in which the vehicle 100 is parked. The first braking force B1 has a constant value F2 > 0 in this time interval. This value corresponds to a value of a clamping force which is applied by at least one (or both) of the service brakes 102-11, 102-22 in their function as parking brakes. The second braking force has a value F0 that is less than F2. F0 can be equal to zero because the service brakes 104-11 and 104-22 are not configured as parking brakes.

At time t1, a driver's wish to start driving is detected. A wish to start driving can be recognized by the actuation of an accelerator pedal, engagement of a gear, etc., for example.

In response to the detection of the wish to start driving, the first braking force B1 is set to a first initial braking force F1A (at time t2) which is lower than the clamping force F2, and the second braking force B2 is set to a second initial braking force F2A (at time t3) which is also lower than the clamping force F2. The driving force FM of the vehicle 100 increases as of the time t1.

The first initial braking force F1A and/or the second initial braking force F2A can be specified and can depend on a vehicle configuration, for instance, and/or on surroundings parameters, such as the gradient of a surface on which the vehicle 100 is standing.

As of the time t2, the first braking force B1 is reduced at a first rate of reduction over time which can depend on the driving force FM of the vehicle 100. As of the time t3, the second braking force B2 is reduced at a second rate of reduction over time which can depend on the driving force FM of the vehicle 100.

Building up a respective initial braking force F1A, F2A on the first axle 102 and also on the second axle 104 of the vehicle 100 at the beginning of the standing-start operation and then reducing it in a defined manner, makes it possible suppress unpleasant pitching of the vehicle 100 when it starts driving. This improves comfort when the vehicle starts driving.

The first and the second rate of reduction can be set such that the driving force FM of the vehicle 100 exceeds a downhill force acting in the opposite direction to the desired direction of travel when starting on a slope, as a result of which unintentional rolling back of the vehicle 100 can be prevented.

Undesirable vibrations of the vehicle 100 when the vehicle starts driving can also be suppressed by ensuring that, during the reduction of the first braking force B1 and the second braking force B2, the second braking force B2 deviates at least temporarily or permanently from the first braking force B1 by at most 5% or at most 10% or at most 20%, and/or that, during the reduction of the first braking force B1 and the second braking force B2, the second rate of reduction over time deviates at least temporarily or permanently by at most 5% or at most 10% or at most 20% from the first rate of reduction over time.

If the vehicle 100 is on a slope when starting, in order to suppress pitching or vibrations when the vehicle starts driving, it can be provided that the first initial braking force F1A and the second initial braking force F2A are each selected independently of one another based on the gradient of a surface on which the vehicle is standing. It can be provided that the second initial braking force F2A deviates from the first initial braking force F1A by at most 5% or at most 10% or at most 20%.

FIG. 3 is a flow chart of an example of a method 200 for controlling the brake system 105 during a standing-start operation of the vehicle 100.

The method 200 comprises:

releasing 210 the locking mechanism 103-11, 103-22,

setting 220 a first braking force B1 on at least one of the first service brakes 102-11, 102-22 to a first initial braking force F1A,

setting 230 a second braking force B2 on at least one of the second service brakes 104-11, 104-22 to a second initial braking force F2A,

reducing 240 the first braking force B1 from the first initial braking force F1A at a first rate of reduction over time and the second braking force B2 from the second initial braking force F2A at a second rate of reduction over time.

What is claimed is:

1. A method for controlling an electromechanical brake system of a vehicle during a standing-start operation of the vehicle, wherein the brake system includes: at least one first electromechanical service brake provided on a first axle of the vehicle and at least one second electromechanical service brake provided on a second axle of the vehicle, wherein the at least one first electromechanical service brake includes a locking mechanism using which the at least one first service brake can also be operated as a parking brake, wherein the method comprises the following steps:
releasing the locking mechanism;
setting a first braking force on the at least one first service brake to a first initial braking force;
setting a second braking force on the at least one second service brake to a second initial braking force; and
reducing the first braking force from the first initial braking force at a first rate of reduction over time and the second braking force from the second initial braking force at a second rate of reduction over time.

2. The method according to claim 1, wherein at least one of the first rate of reduction over time and the second rate of reduction over time depends on a drive state of the vehicle.

3. The method according to claim 2, wherein the drive state of the vehicle includes a driving force of the vehicle or is a driving force of the vehicle.

4. The method according to claim 1, wherein, during the reduction of the first braking force over time and the reduction of the second braking force over time, the second braking force deviates at least temporarily or permanently from the first braking force by at most 5%.

5. The method according to claim 1, wherein, during the reduction of the first braking force over time and the reduction of the second braking force over time, the second rate of reduction over time deviates at least temporarily or permanently from the first rate of reduction over time by at most 5%.

6. The method according to claim 1, wherein the first initial braking force and the second initial braking force are each selected independently of one another based on a gradient of a surface on which the vehicle is standing.

7. The method according to claim 1, wherein the second initial braking force deviates from the first initial braking force by at most 5%.

8. The method according to claim 1, wherein at least one of the first initial braking force and the second initial braking force are less than a parking brake force provided by the at least one first service brake while the at least one first service brake is being operated as a parking brake.

9. A vehicle, comprising:
an electromechanical brake system which comprises: at least one first electromechanical service brake provided on a first axle of the vehicle and at least one second electromechanical service brake provided on a second axle of the vehicle, wherein the at least one first electromechanical service brake includes a locking mechanism using which the at least one first service brake can also be operated as a parking brake; and
a control device configured to control the electromechanical brake system by performing the following steps including:
releasing the locking mechanism,
setting a first braking force on the at least one first service brake to a first initial braking force,
setting a second braking force on the at least one second service brake to a second initial braking force, and
reducing the first braking force from the first initial braking force at a first rate of reduction over time and the second braking force from the second initial braking force at a second rate of reduction over time.
